(19) United States
(12) Patent Application Publication
(10) Pub. No.: US 2004/0043134 A1
(43) Pub. Date: Mar. 4, 2004

(54) Rolled edible thin film products and methods of making same

(76) Inventors: Christine Leclair Corriveau, Orland Park, IL (US); Gwendolyn Jeanne Graff, DeKalb, IL (US); Daniel J. Zyck, North Riverside, IL (US); Albert H. Chapdelaine, Naperville, IL (US)

Correspondence Address: BELL, BOYD & LLOYD LLC, P. O. BOX 1135, CHICAGO, IL, 60690-1135, US

(21) Appl. No.: 10/228,742

(22) Filed: Aug. 27, 2002

(51) Int. Cl. A23G 3/00

(52) U.S. Cl. 426/658

(57) ABSTRACT

Rolled edible thin films and methods of making same are provided. In an embodiment, the rolled edible thin film product includes a container housing a rolled edible thin film. The rolled edible thin film comprises a body that is designed to be segmented by a consumer into a plurality of products that can be separately placed in a mouth of a consumer.

### BACKGROUND OF THE INVENTION

The present invention generally relates to edible compositions. More specifically, the present invention relates to edible film formulations and methods of making and using same.

Edible film products are known in the art. These products are designed to adhere to and rapidly dissolve in the mouth of the consumer. Edible films can provide flavor and/or oral care agents, e.g., breath freshening to the consumer. Such films typically include a film former and flavor or other ingredient. See, for example, U.S. Pat. No. 5,948,430 and U.S. Application Publication No. US2001/0022964 A1.

Edible film products are provided to the consumer in strip form. The strips are usually sized so that they can be placed on the tongue of a consumer. In this regard, the edible film strips typically have a size of a postage stamp or slightly larger. These strips preferably have a supple texture and are non-self adhering.

One type of edible film product is distributed by Pfizer Consumer Healthcare under the name Listerine® PocketPaks™. The Pfizer edible film product is packaged in a plastic container that includes a top that can open along a hinge. A stack of strips are located in an interior of the package one on top of another. The package is designed so that the consumer can open the container and remove one strip from the stack with his or her finger.

Although current edible film strips and packaging provide a viable product, there are some issues with the design. One issue is manufacturing the edible film strip products. Typically, the strips are made from a film that must be cut during manufacturing to the final shape of the strip. This requires specific equipment and increases production time. Further, the cutting and packaging process must be done under specifically controlled conditions. In addition, the step of packaging, e.g., loading the strips into the package, can be time consuming.

A further potential issue is the way the edible film products are dispensed or accessed. As noted above, these products can be provided in a stacked formation requiring the consumer to slide off a strip from the stack with his finger. Sharing of the product by consumers can cause concerns. Moreover, certain consumers may desire a larger or reduced serving size of the strip product. But, due to the size, form, and presentation of the edible film strip, modification of the serving size by the consumer may not be possible.

Of course, it has been known to provide edible products in a variety of shapes and forms. Confectionery products have been molded, extruded, or otherwise shaped into various forms over the years. For example, bubble gum has been formed into shapes such as flat sticks, cylinders, cubes, cigars, shredded chew, and the like. By way of example, U.S. Pat. No. 4,882,175 discloses a method and an apparatus for forming a confectionery product into a rolled or tape form.

It is generally known that providing a confectionery product in a novelty form can enhance the marketability of a product, particularly to young consumers. Edible films could benefit from a new, novel form. Unfortunately though, no practical methods or formulations of making such edible film were previously available. Because edible films are often dry and brittle, or soft and spreadable, these characteristics make edible films difficult to bend and cut. Therefore, manufacturing issues have also limited the type of edible film products that are provided to the consumer.

There is a need for improved edible film products and methods of making same.

### SUMMARY OF THE INVENTION

Generally, the present invention provides rolled edible film formulations and methods of making the same. Pursuant to the present invention, novel forms of consumable edible thin films are provided that can increase the marketability of the product, particularly to younger consumers, reduce manufacturing cost and time, and provide, for at least certain uses, an improvement product.

To this end edible thin films in the form of a rolled tape are provided. The rolled edible film can be of a variety of given lengths, for example, between 1 and 6 feet. By providing rolled edible film, the consumer can segment the film into desired piece sizes for dissolution in oral cavity.

In an embodiment, the present invention provides a rolled edible thin film product comprising a container housing a rolled edible thin film. The rolled edible thin film comprising a body that is designed to be segmented by a consumer into a plurality of pieces that can be separately placed in a mouth of a consumer.

In an embodiment, the rolled edible thin film product comprises a film former and a flavor.

In an embodiment, the container is constructed from a plastic material.

In an embodiment, the container includes a hinge.

In an embodiment, the edible thin film has at least two flavors.

In an embodiment, the edible thin film has at least two colors.

In an embodiment, the edible thin film includes sides that are not parallel.

In an embodiment, the edible thin film includes a surface that is textured.

In an embodiment, at least one side of the edible thin film product includes a design.

In an embodiment, the edible thin film product is so constructed and arranged as to create a tongue tattoo when dissolved in the mouth of a consumer.

In an embodiment, the edible thin film product includes ingredients that create an oral sensation as the product dissolves in the mouth of the consumer.

In an embodiment, the edible thin film product comprises a film former chosen from the group consisting of carboxymethylcellulose, methylcellulose, hydroxypropylmethylcellulose, guar gum, locust bean gum, xanthan gum, carrageenan, algins, propylene glycol, pullulan, pectins, gum arabic, native starches including corn starch, waxy maize starch, high-amylose corn starch, potato, tapioca, rice and wheat starch, modified starches including acid modified, bleached, oxidized, esterified, etherified, crosslinked, and enzymatically-treated starches; starch hydrolyzed products including maltodextrin; protein including gelatin, casein, salts of casein, whey, and protein derived from soybeans; polymers including polyvinyl pyrrolidone, methycrylate copolymer, and carboxyvinyl copolymers.

In an embodiment, the edible thin film product comprises a filler chosen from the group consisting of microcrystalline cellulose, cellulose polymers, including wood, magnesium and calcium carbonate, ground limestone, silicates, including magnesium and aluminum silicate, clay, talc, titanium dioxide, mono-calcium phosphate, di-calcium phosphate, and tri-calcium phosphate.

In an embodiment, the edible thin film product comprises a plasticizer chosen from the group consisting of tallow, hydrogenated tallow, hydrogenated and partially hydrogenated vegetable oils, cocoa butter, sorbitol, glycerin, polyethylene glycol, propylene glycol, invert sugars, corn syrup, lecithin, hydrogenated lecithin, mono-, di- and triglycerides, acetylated monoglycerides, and fatty acids including palmitic, oleic, and linoleic acids.

In an embodiment, the edible thin film product includes a medicament chosen from the group consisting of pH control agents, tartar control, caries control, whitening agents, enzymes, breath freshening agents, anti-plaque/anti-gingivitis agents, saliva stimulating agents, pharmaceutical agents, nutraceutical agents, vitamins, mineral, other like medicaments or combinations thereof.

In an embodiment, the edible thin film product includes a flavor chosen from the group consisting of essential oils, synthetic flavors or mixtures including, but not limited to, oils derived from plants and fruits such as citrus oil, fruit essences, peppermint oil, spearmint oil, other mint oils, clove oils, oil of wintergreen, anise and the like, flavor oils with germ killing properties such as menthol, eucalyptol, thymol, like flavoring agents or combinations thereof.

In an embodiment, the edible thin film product includes an emulsifier chosen from the group consisting of lecithin, food-grade non-ionic emulsifiers, such as fatty acids (C₁₀-C₁₈), mono and diacyl glycerides, ox bile extract, polyglycerol esters, polyethylene sorbitan esters, propylene glycol, sorbitan monopalmitate, sorbitan tristerate, other like emulsifiers or combinations thereof.

In a still further embodiment of the present invention, a rolled edible thin film is provided comprising a film former and an ingredient chosen from the group consisting of flavor and medicament, the rolled edible thin film being so constructed and arranged to allow a consumer to segment a portion of the rolled edible thin film from the remaining portions thereof and place the segmented portion in the consumer's mouth.

In an embodiment, the film includes scored lines that designate segments.

In yet another embodiment of the present invention, a rolled edible thin film product is provided comprising a body defined by a film-former and at least one flavor and a plurality of segments that each designate a serving size.

Moreover, in an embodiment of the present invention, a rolled edible thin film product is provided comprising an elongated body having a length of at least one foot when unrolled.

Still further, the present invention provides in an embodiment a method of producing an edible thin film comprising the steps of forming a film comprising a film former, drying the film, rolling the film into a roll, and packaging a resultant edible thin film product in a package that is designed to be provided to a consumer.

A variety of methods of forming a thin edible film product can be utilized. For example, the method can include the following steps. Initially, all film-forming materials are added together with water and are agitated until all powders are mostly hydrated and few lumps are present. To this mixture, plasticizers, softening agents, colors, sweeteners, cooling agents, flavors and active ingredients are blended together to form a homogeneous solution. This solution is then fed into a hopper, and spread onto a moving substrate through a drying tunnel.

In a currently preferred embodiment, upon exiting the tunnel, the film is creased by scoring the sheet of film along longitudinal lines generally perpendicular to a leading edge of the sheet. After the film sheet is accumulated on a take-up roll, it is separated into individual pieces by breaking the film roll along the score lines. It should be noted that no particular limitation is placed on the length of the rolled film.

Preferably, for packaging purposes, the rolled-up tape of edible film is between about 1 to 8 feet long. In another embodiment, the film product is about 2 to 6 feet long. Still further, the film product can be about 3 to 4 feet long. If the film is wound onto the take-up roll along with the substrate, the film may be unwound from the substrate before or after the roll is separated into individual rolls.

In an embodiment, the film-forming agent is a water-soluble non-starch polysaccharide.

In an embodiment, the film-forming agents include a polysaccharide and a softener.

In an embodiment, the polysaccharide is pullulan.

In another embodiment of the present invention, the film product is a vehicle for delivering active agents to a consumer.

In a further embodiment of the present invention, a method for preparing a rolled film is provided comprising the steps of forming a mixture of at least one film-forming material in powder form and water, agitating the mixture until the powder is mostly hydrated and few lumps remain, adding to the mixture at least one ingredient selected from plasticizers, softening agents, colors, sweeteners, cooling agents, flavors and active ingredients, blending the mixture to obtain a homogeneous solution, spreading the solution onto a moving substrate, drying the solution on the substrate to create a flexible film and winding the film onto a take-up roll.

In an embodiment, the method of producing a rolled film product includes perforating the wet film layer longitudinally before the film layer exits the drying system.

In an embodiment, the method of producing a rolled film product includes separating the wet film layer longitudinally with an air knife before exiting the dryer, peeling the film strips from the substrate upon exiting the dryer, and winding the film strips onto individual take-up rolls.

In an embodiment, the method of producing a rolled film product includes spraying the solution onto multiple narrow carriers that pass through the drying system and are collected individually.

In an embodiment, the method of producing a rolled film product includes slitting the film accumulated onto the take-up roll into narrower width ribbons

In an embodiment, the dried film and the substrate are scored or creased longitudinally prior to winding the film onto a take-up roll.

In an embodiment, only the dried film is scored or creased longitudinally prior to winding the film onto a take-up roll.

In an embodiment, the scored or creased film is separated by breaking it along the score lines after it is wound onto a take-up roll.

In an embodiment, the substrate is separated from the film prior to winding it onto the take-up roll.

In an embodiment, the substrate is separated from the film after winding onto the take-up roll when it is unwound to be rewound on a consumer dispenser roll.

It is an advantage of the present invention to provide improved edible thin film products.

Furthermore, an advantage of the patent invention is to provide an improved method for manufacturing edible thin film products.

Moreover, an advantage of the present invention is to eliminate the separate processes of slitting and cutting to make an individual serving size for the consumer.

Another advantage of the present invention is to provide novel forms of edible thin film product.

Still, another advantage of the present invention is that is decreases the necessary manufacturing floor space.

Yet another advantage of the present invention is that the processing of edible thin films is more efficient.

Furthermore, an advantage of the present invention is that it provides easier methods for the packaging of edible thin films.

Moreover, an advantage of the present invention is that the methods can be implemented by making minor modifications to an otherwise conventional carrier and drying system for production of edible thin films.

Additionally, an advantage of the present invention is that it provides an edible thin film product that is easily accessed and used by the consumer.

Still further, an advantage of the invention is that it provides an improved product/packaging design:

Furthermore, an advantage of the present invention is that it allows consumers to easily modify the serving size of the product.

Additional features and advantages of the present invention are described in, and will be apparent from, the detailed description of the presently preferred embodiments and the drawings.

### BRIEF DESCRIPTION OF THE DRAWINGS

FIG. 1 illustrates an embodiment of the rolled thin edible film of the present invention.

FIG. 2 illustrates an embodiment of the rolled thin edible film product in a package.

### DETAILED DESCRIPTION OF THE INVENTION

The present invention provides rolled edible thin film formulations and products as well as methods of using and making same. As used herein the term “edible thin film” refers to compositions that include a film-former substrate and are designed to adhere to at least a portion of the oral cavity of a consumer and rapidly dissolve therein. “Rapidly dissolve” means that the substrate dissolves in less than 20 seconds, preferably less than 15 seconds and most preferable less than 10 seconds. To “dissolve” means to substantially lose the shape and form of the substrate. An example of an edible thin film product is the Listerine® PocketPaks™ oral care strip sold by Pfizer. As used herein, “rolled” means that the product has an elongated shape and the product is wrapped around itself so that portions of the product overlap other portions of the product. Preferably, the product is wrapped around itself to create a circular cross-sectional shape, although other cross-sectional shapes are possible, e.g., oval, square, triangular, and rectangular.

As noted above, pursuant to the present invention rolled edible thin films are provided. Edible thin films can be formed by a variety of different processes. One such process is as follows: (1) an aqueous solution is formed by blending film-forming materials together with water and are agitated until the powdered materials are mostly hydrated and few lumps are present; (2) to this mixture, plasticizers, softening agents, colors, sweeteners, cooling agents, and active ingredients are blended together to form a homogeneous solution; and (3) this solution is then cast onto a suitable carrier, and dried to form a film.

The carrier material should be impermeable to the film coating, allowing the film coating to disperse evenly onto the carrier. This also allows for ease of removal of the film from the carrier. Examples of suitable carriers include plastic or polyester films, polypropylene, polycarbonate, non-siliconized polyethylene terephthalate film, non-siliconized Kraft paper, polyethylene impregnated Kraft paper, metal belts, voltage or corona treated belts, drum dryers, and polytetrafluroethylene-impregnated glass fabric. Multiple carriers may be employed to create a multi-layered film product.

It has been found that a particularly preferred method of casting the film on the carrier may be through use of a slot die extrusion. By use of multiple extruders and specially constructed dies, it is possible to add multiple color stripes or designs to the product. It is also possible to oscillate the die head to produce wavy lines on the product. The resulting films can be laminated to produce various visual effects.

The casting of the solution onto a suitable carrier material can be performed using any conventional coating technique. Examples of coating techniques include spraying, dipping, comma coaters, knife over plate, roll over roll, reverse roll, slot die extrusion, and various extrusion techniques. Film thickness can be controlled by adjusting the gap on the coating head, or by applying the desired amount of the solution onto the substrate/carrier.

It should be noted that no particular limitation is placed on the thickness of the film layer except that the resultant film must rapidly dissolve in the mouth of the consumer. Therefore the thickness of the film can be varied based on, for example, the desired speed of dissolution of the edible film while in the oral cavity. Not only can the thickness be varied but a multi-layered film product may be provided.

After the coating step, in an embodiment, the film passes through a dryer for moisture reduction. In the dryer, drying is carried out through a variety of different means, such as high velocity turbulent hot air, conduction from steam heated slide bed, direct heating or casting of film onto a heated drum or belt, hot or cold air impingement, infrared heating, or any other suitable drying equipment that does not adversely affect the components of the film.

Once the film exits the drying system, the dried film can be either taken-up along with its substrate or peeled from the carrier to form a wide roll. As the film exits the drying system, it can be exposed to a number of different types of treatments. The film may be sprinkled with sugar, starch, flavor, color enhancers such as glitter, acids, bioadhesives, actives and texturizers such as candy sprinkles to make specialty edible thin film products directed to younger consumers.

In an embodiment, before or after exiting the drying system, the film may be creased or perforated by scoring the film along lines generally perpendicular to the leading edge of the sheet (i.e. longitudinal lines). This can be accomplished with or without creasing its carrier backing. These perforations or creases may be adjusted to yield a desired width of the consumer film product.

Once the wide roll has been dried, and the carrier has been creased along with the film layer, the wide roll is broken down into more narrow rolls according to score lines, and may be packaged immediately. If the substrate is present, the roll may be unwound and then packaged, or packaged with the substrate remaining intact and separated once a consumer wishes to consume a particular amount of the product. Further, if only the film layer was perforated during processing, a “peel-and-pull” type of product may also manufactured.

Another method of manufacturing rolled edible thin film products includes separating the wet film layer longitudinally with an air knife before exiting the dryer. The film strips are peeled from the substrate upon exiting the dryer. The film strips are then wound onto individual take-up rolls. Once the narrow film strips are taken-up, they can be packaged immediately.

The rolled edible thin film product may also be manufactured by spraying the solution onto multiple narrow carriers. The carriers are then passed through the drying system and are collected individually.

Another method for making a rolled edible film product is to generate a single wide roll upon exiting the dryer. The roll is then slit and unwound into narrower rolls. The rolls can then have a width of the desired serving size. Various slitting techniques may be employed, such as rotary shear slitting, surface wound duplex slitting, and duplex center drive razor slitting. Once the films have been slit, they can be packaged immediately.

In an embodiment, a substrate can be located on one or both of the surfaces of the edible thin film so as to ensure the surfaces of the film do not stick to one another on the rolled film. The substrate can be a plastic or paper backing. As an alternative, a powder can be located between the surfaces, e.g., an edible powder such as sugar. A variety of methods can be utilized to separate the surfaces if there is a concern that the film may stick to itself.

As previously discussed an advantage of the present invention is that it eliminates the final cutting step that is necessary in order to achieve a desired serving size. The elimination of this step is advantageous as typically the step is performed under tightly controlled temperature and humidity conditions or once the film has been aged properly. Further, constant exposure to air during the cutting process may cause moisture loss in the film, making it dry, brittle, and difficult to handle. By maintaining the roll form of the thin film upon exiting the dryer as the final product, there is a great reduction in production times, and the films are less likely to fail if exposed to environmental conditions since they can be quickly packaged in their rolled form.

Packaging the film as a roll also provides significant processing advantages over packaging cut-to-size pieces, e.g., strips. The roll is handled as a single unit rather than a plurality of individual pieces. Handling the roll is more amenable to automated packaging as the individual sheets are relatively small and light and subject to static electric charge and air currents.

Further, the present invention allows the rolled films of the present invention to provide specialty edible thin films. These specialty edible thin films can be produced at various points during the film making process. A variety of products are possible, particularly those concepts which appeal to younger consumers. Types of specialty edible thin film products include, but are not limited to, films that are multi-flavoring, multi-layering, multi-coloring, multi-shapes or forms, texturizing, laminating, printing, graphical designs, “tongue-tattoos”, oral sensations, varying dissolution profiles, bioadhesive components, within the oral mucosa of a consumer; alone or in combinations thereof. The edible thin films of the present invention are also suitable for food applications beyond direct consumption.

The rolled edible thin film products can comprise a large number of suitable formulations. Any suitable water-soluble, film-former can be used to produce a rolled edible thin film product. Suitable film-formers include but are not limited to water-soluble non-starch polysaccharides such as carboxymethylcellulose (CMC), methylcellulose, hydroxypropylmethylcellulose (HPMC), guar gum, locust bean gum, xanthan gum, carrageenan, algins, propylene glycol, levan, elsinan, pullulan, pectins, chitosan, and gum arabic; native starches such as corn starch, waxy maize starch, high-amylose corn starch, potato, tapioca, rice and wheat starch; modified starches such as those that have been acid modified, bleached, oxidized, esterified, etherified, crosslinked, and treated enzymatically; starch hydrolyzed products such as maltodextrin; protein such as albumen, gelatin, casein, salts of casein, whey, wheat gluten, zein, and protein derived from soybeans; polymers such as polyvinyl pyrrolidone, methycrylate copolymer, and carboxyvinyl copolymers alone or in any combination. In an embodiment, the concentration of the film-forming agent constitutes between 5% to about 60% by dry weight, or 20% to about 40% by dry weight of the final film composition.

Further, any suitable food-grade bulk filler can also be added to produce the film. Such fillers can reduce any slimy texture as well as provide structure to the film making it more palatable. In an embodiment, the filler can comprise approximately 1% to about 30% by dry weight of the film, or approximately 5% to about 15% by dry weight of the film. The filler can include microcrystalline cellulose, cellulose polymers, such as wood, magnesium and calcium carbonate, ground limestone, silicates, such as magnesium and aluminum silicate, clay, talc, titanium dioxide, mono-calcium phosphate, di-calcium phosphate, tri-calcium phosphate, other like bulk fillers or combinations thereof.

If it is desired to use lower levels of film forming agents, softeners can also be employed to ensure the flexibility of the film, thereby reducing brittleness. The softeners, which are also known as plasticizers, may include tallow, hydrogenated tallow, hydrogenated and partially hydrogenated vegetable oils, cocoa butter, sorbitol and other polyols, glycerin, polyethylene glycol, propylene glycol, invert sugars, corn syrup, lecithin, hydrogenated lecithin, mono-, di- and triglycerides, acetylated monoglycerides, fatty acids (e.g. stearic, palmitic, oleic, and linoleic acids), and combinations thereof. In an embodiment, the softener can constitute 0% to about 20% by dry weight of the film, or approximately 2% to about 10% by dry weight of the film.

Another means of controlling the brittleness of the film is to maintain an adequate moisture level in the film. Preferably, moisture levels should range from approximately 5% to about 20%, or approximately 10% to about 15% of the final film product.

A variety of other suitable ingredients can be added to the rolled edible thin film of the present invention. For example, any suitable medicament for oral cleansing, breath freshening or the like can be added to the film formulation. The medicaments can include, for example, pH control agents, tartar control, caries control, whitening agents, enzymes, breath freshening agents, anti-plaque/anti-gingivitis agents, saliva stimulating agents, pharmaceutical agents, nutraceutical agents, vitamins, mineral, other like medicaments or combinations thereof.

If desired, the rolled edible thin film formulations of the present invention can also include colorants or coloring agents which can be used in any suitable amount to produce a desired color. Further, the rolled edible thin films of the present invention may have colored stripes and/or other related designs or shapes to produce color contrasts on the edible rolled film. Additional coloring may be used to intentionally dye the tongue of the consumer. Coloring agents can include, for example, natural food colors and dyes suitable for food, drug, and cosmetic applications. The colorants are typically known as FD&C dyes and lakes.

A variety of flavoring agents can also be added to the rolled edible thin films. Any suitable amount and type of artificial and/or natural flavoring agents can be used in any sensorially acceptable fashion. For example, the flavor can constitute about 0.1% to about 20% by dry weight of the film, preferably approximately 10% to about 15%. The flavoring agent can include, for example, essential oils, synthetic flavors or mixtures including but not limited to oils derived from plants and fruits such as citrus oil, fruit essences, peppermint oil, spearmint oil, other mint oils, clove oils, oil of wintergreen, anise and the like, flavor oils with germ killing properties such as menthol, eucalyptol, thymol, like flavoring agents or combinations thereof.

The flavor can be enhanced and distributed evenly throughout the product by emulsification. Any suitable amount and type of natural and/or synthetic food-grade emulsifier can be used. For example, the emulsifier can include lecithin, food-grade non-ionic emulsifiers, such as fatty acids (C₁₀-C₁₈), mono and diacyl glycerides, ox bile extract, polyglycerol esters, polyethylene sorbitan esters, propylene glycol, sorbitan monopalmitate, sorbitan tristerate, other like emulsifiers or combinations thereof.

The flavors can be emulsified by any suitable emulsification process, such as mechanical processing, vigorous stirring, intense pressure fluctuations that occur in turbulent flow such as homogenization, sonification, colloid milling and the like. Further, the flavors may also be encapsulated or spray dried onto the rolled edible thin film product to enhance flavor properties or to add texture to the film composition.

Sweetening agents may also be used in the edible film products of the present invention. Sugar sweeteners generally include saccharide-containing components including, but not limited to, sucrose, dextrose, maltose, dextrin, invert sugar, fructose, levulose, galactose, corn syrup solids, and the like, alone or in any combination. Sugarless sweeteners include, but are not limited to, sugar alcohols such as sorbitol, mannitol, xylitol, isomalt, hydrogenated starch hydrolysates, maltitol, and the like, alone or in any combination. However, the low weight of the film products of the present invention generally render these low intensity sweeteners ineffective for purposes of sweetening although they may provide functional benefits. Any suitable amount of sweetening agent can be used.

High intensity artificial sweeteners may preferably be used, alone or in combination with the above. Preferred sweeteners include, but are not limited to, sucralose, aspartame, N-substituted APM derivatives such as neotame, salts of acesulfame, alitame, saccharin and its salts, cyclamic acid and its salts, glycyrrhizin, dihydrochalones, thaumatin, monellin, and the like, alone or in any combination. In order to provide enhanced or delayed sweetness, or to provide texture to the rolled film product, it may be desirable to encapsulate the sweetener. Such techniques as wet granulation, wax granulation, spray drying, spray chilling, fluid bed coating, coacervation, and fiber extension may be used to achieve the desired characteristics.

Combinations of sugar and/or sugarless sweeteners may be used in the film product. Additionally, a softening agent may also provide additional sweetness such as with aqueous sugar or alditol solutions.

Cooling agents may also be employed in the present invention, cooling agents include, but are not limited to, menthol, WS3, WS23, Ultracool, monomenthyl succinate, alone or in any combination. Again, these cooling agents may be encapsulated or spray dried onto the film to enhance a variety of oral sensations.

Depending on the ingredients being used to make the edible thin film product, preservatives may also be employed to ensure the safety and quality of the edible thin film. Suitable preservatives include, but are not limited to, sorbic acid, sodium benzoate, potassium sorbate, methyl p-hydroxybenzoate, sodium propionate, and propyl p-hydroxybenzoate alone or in any combination. In addition, suitable antioxidants can also be utilized.

It should be appreciated that any suitable type, number and arrangement of process procedures or steps (e.g. mixing, heating, drying, cooling, addition of ingredients), process parameters (e.g. temperature, pressure, pH, process times) or the like can be utilized to practice the present invention.

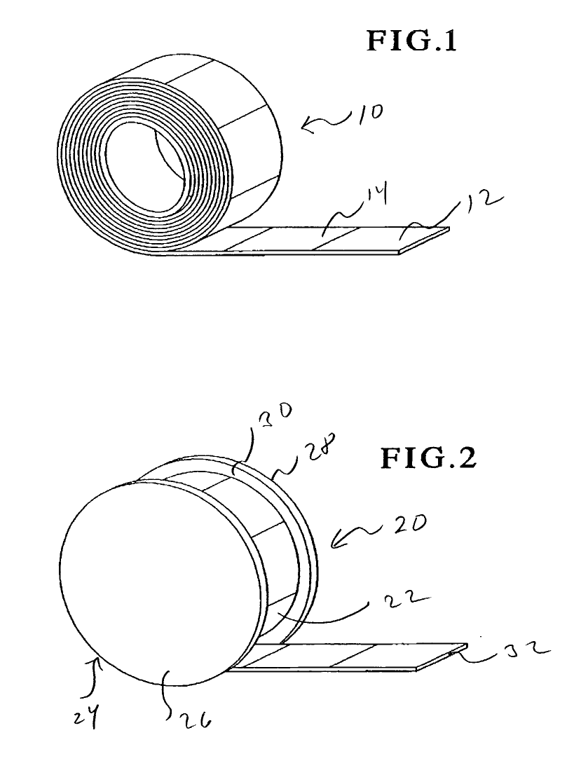

Referring now to FIG. 1, an embodiment of the rolled edible thin film product 10 is illustrated. In the illustrated embodiment, the product 10, is rolled so that it has a circular cross-sectional shape. However, it should be noted that the rolled film product 10 can have a variety of cross-sectional shapes.

Additionally, in the embodiment illustrated, the product 10 includes a plurality of segments 12 and 14 that are generally delineated by a scored line 16. These segments 12 and 14 can be separated by the consumer along the scored line 16 or at another location. Of course, if scored lines are not necessary and the product can include a surface with no segmentations or other means of creating segments, e.g., a crease or fold, what is important is that an elongated body is provided to the consumer that can be broken, torn, or otherwise segmented into desired serving sizes.

Referring now to FIG. 2, an embodiment of a packaged rolled edible thin film product 20 is illustrated. As illustrated the rolled edible thin film 22 is removably stored in a container 24 including walls 26 and 28 that define an interior 30. The walls 26 and 28 can be surrounded by a wall or similar enclosure that allows the consumer to access an end 32 of the film but encloses the remaining portions of the edible film 22. Preferably, the container 24 is constructed from plastic.

Of course, a variety of package/container designs are possible. Such designs would include, for example, containers allowing the rolled thin film to be accessed by opening walls that are hinged together, pulling the film through a slot in the container, or a variety of other means. It should be noted that any container design can be used as long as it allows the consumer to access the thin film.

By way of example and not limitation, the following examples illustrate various embodiments of the rolled edible film formulations of the present invention.

### EXAMPLES

(% Finished Wt.)

| Ingredient | Ex. 1 | Ex. 2 | Ex. 3 | Ex. 4 | Ex. 5 | Ex. 6 |
|---|---|---|---|---|---|---|
| Corn Starch | 25.0 | — | — | 30.0 | — | — |
| Hydroxypropylated Starch | — | — | — | — | — | 47.35 |
| Carrageenan | 14.0 | 12.0 | 10.0 | — | 9.0 | — |
| Glycerin | 10.0 | 8.0 | — | 5.0 | 9.0 | 7.50 |
| Gelatin | — | — | 12.0 | 5.0 | — | 2.50 |
| Microcrystalline Cellulose | 3.0 | 7.0 | — | 5.0 | 8.0 | — |
| Sodium Alginate | — | 25.0 | 10.0 | 5.0 | 30.0 | 22.0 |
| Maltodextrin | — | 20.5 | — | — | 18.0 | — |
| Pullulan | 6.0 | — | 40.0 | — | — | — |
| Sorbitol | 15.0 | — | — | 5.0 | — | — |
| Liquid Sorbitol | — | — | — | 10.0 | — | — |
| Acesulfame K | — | — | — | — | — | 1.0 |
| Sucralose | — | 1.45 | 1.0 | 1.0 | — | 1.25 |
| Aspartame | 1.50 | — | 2.0 | — | 2.0 | — |
| WS-3 | — | 1.55 | — | 1.0 | — | — |
| WS-23 | — | — | 2.0 | — | — | — |
| Menthol | — | 6.0 | 1.0 | — | 3.0 | 1.0 |
| Spearmint | — | — | — | — | 6.0 | — |
| Cherry Flavor | 15.0 | 5.0 | — | 12.0 | — | — |
| Peppermint | — | — | — | — | 6.0 | — |
| Eucalyptol | — | — | — | — | — | 6.00 |
| Methyl Salicylate | — | 5.0 | 10.0 | — | — | — |
| Citric Acid | — | — | — | 5.0 | 1.0 | — |
| Adipic Acid | — | — | — | — | — | 1.00 |
| Color | 0.50 | 0.50 | — | 0.50 | 0.35 | 0.40 |
| Water | 10.0 | 8.0 | 12.0 | 15.5 | 7.65 | 10.0 |
| Total | 100.0 | 100.0 | 100.0 | 100.0 | 100.0 | 100.0 |

(% Finished Wt.)

| Ingredient | Ex. 7 | Ex. 8 | Ex. 9 | Ex. 10 | Ex. 11 | Ex. 12 |
|---|---|---|---|---|---|---|
| Hydroxyethylated Starch | — | 48.0 | — | — | — | — |
| PURE-COTE ® B790* | 50.0 | — | — | — | — | — |
| Enzyme Hydrolyzed Corn | — | — | 22.0 | — | — | — |
| Starch | | | | | | |
| Maltodextrin | — | — | 5.0 | 28.0 | — | — |
| Casein | — | 2.9 | — | — | 3.5 | — |
| Pullulan | — | — | 20.0 | — | — | 35.0 |
| Polyvinyl Pyrollidone | — | 11.0 | — | — | 6.0 | — |
| Hydroxypropylmethylcellulos | — | — | — | — | 30.0 | — |
| Xanthan Gum | — | — | — | — | — | 6.0 |
| Locust Bean Gum | — | — | — | — | — | 8.0 |
| Glycerin | — | — | — | 12.0 | 9.5 | 10.5 |
| Polyethylene Glycol | — | — | — | — | 6.0 | — |
| Propylene Glycol | 1.50 | — | 10.0 | — | 6.0 | — |
| Carrageenan | — | 11.0 | — | 10.0 | — | 25.0 |
| Sodium Alginate | — | — | — | 13.75 | — | — |
| Calcium Alginate | 22.9 | — | — | — | — | — |
| Silica | — | — | — | 5.0 | — | — |
| Calcium Carbonate | — | — | 3.0 | — | — | — |
| Pectin | 4.0 | — | — | — | — | — |
| Lecithin | — | 2.0 | 1.0 | 1.5 | — | — |
| Saccharin | — | — | — | — | — | 2.0 |
| Aspartame | 0.25 | — | — | 1.0 | 1.5 | — |
| Sucralose | 1.25 | — | — | — | — | — |
| Neotame | — | — | 0.50 | — | 1.5 | — |
| Encapsulated Acesulfame K | — | — | 1.5 | — | 1.0 | — |
| Corn Syrup | — | — | 15.0 | — | — | — |
| Guar Gum | — | 2.0 | — | — | — | — |
| Sorbitan Monopalmitate | — | — | — | — | 4.0 | — |
| Ultracool | — | — | — | 1.5 | — | 5.0 |
| Citric Acid | — | — | — | 1.5 | — | — |
| Adipic Acid | — | — | — | 1.5 | — | — |
| Methyl Salicylate | — | — | — | — | — | 1.5 |
| Eucalyptol | — | 6.0 | — | — | — | 0.5 |
| Thymol | — | — | 3.0 | — | — | 0.5 |
| Encapsulated Peppermint | — | — | — | — | 12.0 | — |
| Menthol | — | — | 8.0 | — | 4.0 | 1.5 |
| Lemon Flavor | 11.0 | — | — | 8.0 | — | — |
| Mixed Berry Flavor | — | 5.0 | — | 8.0 | — | — |
| Color | 0.05 | 0.10 | 0.50 | 0.25 | — | 0.5 |
| Water | 9.05 | 12.0 | 10.5 | 8.0 | 15.0 | 4.0 |
| Total | 100.0 | 100.0 | 100.0 | 100.0 | 100.0 | 100.0 |

| | (% Finished Wt.) | | | | | | | |
|---|---|---|---|---|---|---|---|---|
| Ingredient | Ex. 13 | Ex. 14 | Ex. 15 | Ex. 16 | Ex. 17 | Ex. 18 | Ex. 19 | Ex. 20 |
| Hydroxypropylcellulose | 45.0 | — | — | — | — | — | 18.0 | — |
| Waxy Maize Starch | — | 26.0 | — | — | — | — | 15.0 | — |
| Potato Starch | 2.0 | — | 29.5 | — | — | — | — | — |
| Pullulan | — | — | 8.0 | — | 55.0 | — | — | — |
| Microcrystalline | — | — | 10.0 | 6.5 | — | 8.0 | — | 6.5 |
| Cellulose | | | | | | | | |
| Sucrose Fatty Acid | — | — | 1.0 | — | — | — | 3.0 | — |
| Ester | | | | | | | | |
| Maltodextrin | — | 19.0 | — | 20.0 | — | 28.0 | — | 19.0 |
| Carrageenan | — | 16.0 | — | 10.0 | — | 8.0 | 1.5 | 10.0 |
| Gelatin | 7.0 | — | — | — | 2.0 | — | — | — |
| Polyvinyl Alcohol | 6.0 | — | — | — | — | — | — | — |
| Sodium Polyacrylate | 5.0 | — | — | — | — | — | — | — |
| Carboxymethylcellulose | 5.0 | — | — | — | — | — | — | — |
| Xanthan Gum | — | 3.0 | — | — | — | — | — | — |
| Karaya Gum | 3.5 | — | — | — | 6.0 | — | — | — |
| Glycerin | — | — | — | 6.0 | — | 4.5 | — | 6.0 |
| Titanium Dioxide | — | — | 2.0 | — | — | — | 2.5 | — |
| Sodium Alginate | — | — | — | 25.0 | 2.0 | 27.0 | 13.0 | 19.0 |
| Sorbitol | — | — | 1.5 | — | — | 0.05 | — | — |
| Encapsulated | — | — | — | — | — | — | 1.0 | — |
| Aspartame | | | | | | | | |
| Sucralose | — | — | — | — | — | 1.5 | 1.0 | 3.0 |
| Corn Syrup | — | — | 1.0 | — | — | — | — | — |
| Soybean Oil | — | — | 15.4 | — | — | — | — | — |
| Lecithin | — | — | — | 1.5 | 0.5 | 0.50 | — | 1.5 |
| Dextrose | — | — | 2.0 | — | — | — | — | — |
| Fructose | — | 10.0 | — | — | 5.0 | — | — | — |
| WS-3 | — | 2.9 | — | 1.0 | — | — | 4.0 | 0.5 |
| Clove Oil | — | — | 1.0 | — | 4.5 | — | — | — |
| Menthol | 8.0 | 2.0 | — | 2.0 | — | — | 1.0 | 0.5 |
| Grape Flavor | — | — | — | — | — | — | 12.0 | 5.0 |
| Lemon Flavor | — | — | — | — | — | 5.0 | — | — |
| Rose Oil | — | 2.0 | — | — | — | — | 1.0 | — |
| Pepper | — | 2.0 | — | — | — | — | — | — |
| Orange Flavor | — | — | 3.0 | — | — | 4.0 | 2.0 | — |
| Peppermint Oil | — | — | — | 10.0 | 5.0 | 2.0 | — | — |
| Cardamom | 8.0 | 2.0 | — | — | — | 1.0 | — | — |
| Grapeseed Extract | — | — | — | 5.2 | 2.5 | — | — | — |
| Tea Catechins | — | — | — | — | — | 1.0 | — | — |
| Vitamin C | — | — | 3.0 | — | 2.5 | — | 5.0 | 9.9 |
| Vitamin A, B, D, E | — | — | — | — | — | — | — | 5.0 |
| Complex | | | | | | | | |
| Zinc Gluconate | — | — | — | — | — | — | 5.0 | 1.0 |
| Sodium Selenite | — | — | — | — | — | — | — | 0.001 |
| Encapsulated Reduced | — | — | — | — | — | — | — | 3.0 |
| Iron | | | | | | | | |
| Citric Acid | — | — | 2.0 | — | — | — | 5.0 | — |
| Echinacea | — | — | 3.0 | — | 2.5 | 1.0 | — | — |
| Cetyl Pyridinium | 3.0 | — | — | — | — | — | — | — |
| Chloride | | | | | | | | |
| Encapsulated Caffeine | — | 5.0 | — | — | — | — | — | — |
| Sodium Benzonate | — | — | — | 2.0 | 0.5 | — | — | — |
| BHA | — | — | — | 0.5 | — | 0.05 | — | — |
| Color | 0.5 | 0.1 | 0.6 | 0.30 | 0.5 | 0.80 | 0.1 | 0.1 |
| Water | 7.0 | 10.0 | 17.0 | 10.0 | 11.5 | 7.6 | 9.9 | 9.999 |
| Total | 100.0 | 100.0 | 100.0 | 100.0 | 100.0 | 100.0 | 100.0 | 100.0 |

*PURE-COTE ® B790 is a product of the Grain Processing Corporation (GPC), located in Muscatine, Iowa. PURE-COTE ® B790 is a flash-dried modified corn starch designed specifically for applications requiring very low viscosity.

Preparation Methods:

1) Blending:

a) Powdered materials (such as film-forming agents) are blended together using a ribbon blender or similar type device.

b) Flavors and flavor components/enhancers are blended together using mechanical agitation or other means.

2) Mixing:

a) The powdered mix is added to a mixing tank filled with the appropriate amount of water.

b) After the powdered mix is mostly hydrated, the temperature is increased and softening agents, color, and sweetener are added in succession while the solution temperature is raising. The blend is maintained at an even temperature, about 105-115° F.

c) The conditions of the mixing room are about 70-80° F. and 40-50% RH.

3) Drying:

a) The solution is fed into a feed hopper.

b) Upon entering the drying system, the film is perforated along lines generally perpendicular to the leading edge of the sheet using a comb or bar.

c) The heater temperature is adjusted to achieve an exit film temperature of about 215-220° F. This should produce a film having a moisture of about 9-11%.

d) The coma roll is adjusted to produce a dry thickness of about 48-52 microns.

e) Drying room conditions are about 70-80° F. and 40-50% RH.

4) Separating:

a) The take-up roll is then broken down into narrower rolls along the score lines created while in the drying system.

b) The resultant edible thin film roll is then unwound from the substrate and packaged as desired.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A rolled edible thin film product comprising:
a container housing a rolled edible thin film; and
the rolled edible thin film comprising a body that is designed to be segmented by a consumer into a plurality of pieces that can be separately placed in a mouth of a consumer.

2. The rolled edible thin film product of claim 1 comprising a film former and a flavor.

3. The rolled edible thin film product of claim 1 wherein the container is constructed from a plastic material.

4. The rolled edible thin film product of claim 1 wherein the edible thin film has at least two flavors.

5. The rolled edible thin film product of claim 1 wherein the container includes a hinge.

6. The rolled edible thin film product of claim 1 wherein the edible thin film has at least two colors.

7. The rolled edible thin film product of claim 1 wherein the edible thin film includes sides that are not parallel.

8. The rolled edible thin film product of claim 1 wherein the edible thin film includes a surface that is textured.

9. The rolled edible thin film product of claim 1 wherein at least one side of the edible thin film includes a design.

10. The rolled edible thin film product of claim 1 wherein the edible film releases color to dye a tongue in the mouth of the consumer.

11. The rolled edible thin film product of claim 1 wherein the edible thin film is so constructed and arranged so as to create a tongue tattoo when dissolved in the mouth of a consumer.

12. The rolled edible thin film product of claim 1 wherein the edible thin film includes ingredients that create an oral sensation as the product dissolves in the mouth of the consumer.

13. The rolled edible thin film product of claim 1 wherein the edible thin film comprises a film former chosen from the group consisting of carboxymethylcellulose, methylcellulose, hydroxypropylmethylcellulose, guar gum, locust bean gum, xanthan gum, carrageenan, algins, propylene glycol, pullulan, levan, elsinan, pectins, chitosan, gum arabic, native starches including corn starch, waxy maize starch, high-amylose corn starch, potato, tapioca, rice and wheat starch, modified starches including acid modified, bleached, oxidized, esterified, etherified, crosslinked, and enzymatically-treated starches; starch hydrolyzed products including maltodextrin; protein including albumen, gelatin, casein, salts of casein, whey, wheat gluten, zein, and protein derived from soybeans; polymers including polyvinyl pyrrolidone, methycrylate copolymer, and carboxyvinyl copolymers.

14. The rolled edible thin film product of claim 1 wherein the edible thin film comprises a filler chosen from the group consisting of microcrystalline cellulose, cellulose polymers, including wood, magnesium and calcium carbonate, ground limestone, silicates, including magnesium and aluminum silicate, clay, talc, titanium dioxide, mono-calcium phosphate, di-calcium phosphate, and tri-calcium phosphate.

15. The rolled edible thin film product of claim 1 wherein the edible thin film comprises a plasticizer chosen from the group consisting of tallow, hydrogenated tallow, hydrogenated and partially hydrogenated vegetable oils, cocoa butter, sorbitol, glycerin, polyethylene glycol, propylene glycol, invert sugars, corn syrup, lecithin, hydrogenated lecithin, mono-, di- and triglycerides, acetylated monoglycerides, and fatty acids including palmitic, oleic, and linoleic acids.

16. The rolled edible thin film product of claim 1 wherein the edible thin film includes a medicament chosen from the group consisting of pH control agents, tartar control, caries control, whitening agents, enzymes, breath freshening agents, anti-plaque/anti-gingivitis agents, saliva stimulating agents, pharmaceutical agents, nutraceutical agents, vitamins, and minerals.

17. The rolled edible thin film product of claim 1 wherein the edible thin film includes a flavor chosen from the group consisting of essential oils, citrus oil, fruit essences, peppermint oil, spearmint oil, mint oils, clove oils, oil of wintergreen, anise, flavor oils, with germ killing properties including menthol, eucalyptol, thymol, and synthetic flavors.

18. The rolled edible thin film product of claim 1 wherein the edible thin film includes an emulsifier chosen from the group consisting of lecithin, food-grade non-ionic emulsifiers, such as fatty acids (C₁₀-C₁₈), mono and diacyl glycerides, ox bile extract, polyglycerol esters, polyethylene sorbitan esters, propylene glycol, sorbitan monopalmitate, and sorbitan tristerate.

19. A rolled edible thin film comprising a film former and an ingredient chosen from the group consisting of flavor and medicament, the rolled edible thin film being so construct and arrange so as to allow a consumer to segment a portion of the rolled edible thin film from the remaining portions thereof and place the segmented portion in the consumer's mouth.

20. The rolled edible thin film of claim 19 wherein the edible thin film includes a plurality of scored lines that define segments.

21. The rolled edible thin film of claim 19 wherein the edible thin film has at least two flavors.

22. The rolled edible thin film of claim 19 wherein the edible thin film includes a plurality of folds that define segments.

23. The rolled edible thin film of claim 19 wherein the edible thin film has at least two colors.

24. The rolled edible thin film of claim 19 wherein the edible thin film includes sides that are not parallel.

25. The rolled edible thin film of claim 19 wherein the edible thin film includes a surface that is textured.

26. The rolled edible thin film of claim 19 wherein at least one side of the edible thin film product includes a design.

27. The rolled edible thin film of claim 19 wherein the edible film releases color to dye a tongue of the consumer when dissolved in the mouth of a consumer.

28. The rolled edible thin film of claim 19 wherein the edible thin film product is so constructed and arranged so as to create a tongue tattoo when dissolved in the mouth of a consumer.

29. The rolled edible thin film of claim 19 wherein the edible thin film includes ingredients that create an oral sensation as the product dissolves in the mouth of a consumer.

30. The rolled edible thin film of claim 19 wherein the edible thin film comprises a film former chosen from the group consisting of carboxymethylcellulose, methylcellulose, hydroxypropylmethylcellulose, guar gum, locust bean gum, xanthan gum, carrageenan, algins, propylene glycol, levan, elsinan, pullulan, pectins, chitosan, gum arabic, native starches including corn starch, waxy maize starch, high-amylose corn starch, potato, tapioca, rice and wheat starch, modified starches including acid modified, bleached, oxidized, esterified, etherified, crosslinked, and enzymatically-treated starches; starch hydrolyzed products including maltodextrin; protein including albumen, gelatin, casein, salts of casein, whey, wheat gluten, zein, and protein derived from soybeans; polymers including polyvinyl pyrrolidone, methycrylate copolymer, and carboxyvinyl copolymers.

31. The rolled edible thin film of claim 19 wherein the edible thin film comprises a filler chosen from the group consisting of microcrystalline cellulose, cellulose polymers, including wood, magnesium and calcium carbonate, ground limestone, silicates, including magnesium and aluminum silicate, clay, talc, titanium dioxide, mono-calcium phosphate, di-calcium phosphate, and tri-calcium phosphate.

32. The rolled edible thin film of claim 19 wherein the edible thin film comprises a plasticizer chosen from the group consisting of tallow, hydrogenated tallow, hydrogenated and partially hydrogenated vegetable oils, cocoa butter, sorbitol, glycerin, polyethylene glycol, propylene glycol, invert sugars, corn syrup, lecithin, hydrogenated lecithin, mono-, di- and triglycerides, acetylated monoglycerides, and fatty acids including palmitic, oleic, and linoleic acids.

33. The rolled edible thin film of claim 19 wherein the edible thin film includes a medicament chosen from the group consisting of pH control agents, tartar control, caries control, whitening agents, enzymes, breath freshening agents, anti-plaque/anti-gingivitis agents, saliva stimulating agents, pharmaceutical agents, nutraccutical agents, vitamins, and minerals.

34. The rolled edible thin film of claim 19 wherein the edible thin film includes a flavor chosen from the group consisting of essential oils, synthetic flavors, citrus oil, fruit essences, peppermint oil, spearmint oil, mint oils, clove oils, oil of wintergreen, anise, flavor oils with germ killing properties including menthol, eucalyptol, and thymol.

35. The rolled edible thin film of claim 19 wherein the edible thin film includes an emulsifier chosen from the group consisting of lecithin, food-grade non-ionic emulsifiers, such as fatty acids (C₁₀-C₁₈), mono and diacyl glycerides, ox bile extract, polyglycerol esters, polyethylene sorbitan esters, propylene glycol, sorbitan monopalmitate, and sorbitan tristerate.

36. A rolled edible thin film comprising a body defined by a film-former and at least one flavor, the body including a plurality of segments that each designate a serving size.

37. The rolled edible thin film of claim 36 wherein the body has a length of between 1 and 8 feet.

38. The rolled edible thin film of claim 36 wherein the segments are defined by scored lines.

39. The rolled edible thin film of claim 36 wherein the edible thin film has at least two flavors.

40. The rolled edible thin film of claim 36 wherein the segments are defined by creases.

41. The rolled edible thin film of claim 36 wherein the edible thin film has at least two colors.

42. The rolled edible thin film of claim 36 wherein the edible thin film includes sides that are not parallel.

43. The rolled edible thin film of claim 36 wherein the edible thin film includes a surface that is textured.

44. The rolled edible thin film of claim 36 wherein at least one side of the edible thin film includes a design.

45. The rolled edible thin film of claim 36 wherein the edible thin film is so constructed and arranged as to create a tongue tattoo when dissolved in the mouth of a consumer.

46. The rolled edible thin film of claim 36 wherein the edible thin film includes ingredients that create an oral sensation as the product dissolves in the mouth of the consumer.

47. The rolled edible thin film of claim 36 wherein the edible thin film comprises a film former chosen from the group consisting of carboxymethylcellulose, methylcellulose, hydroxypropylmethylcellulose, guar gum, locust bean gum, xanthan gum, carrageenan, algins, propylene glycol, levan, elsinan, pullulan, pectins, chitosan, gum arabic, native starches including corn starch, waxy maize starch, high-amylose corn starch, potato, tapioca, rice and wheat starch, modified starches including acid modified, bleached, oxidized, esterified, etherified, crosslinked, and enzymatically-treated starches; starch hydrolyzed products including maltodextrin; protein including albumen, gelatin, casein, salts of casein, whey, wheat gluten, zein, and protein derived from soybeans; polymers including polyvinyl pyrrolidone, methycrylate copolymer, and carboxyvinyl copolymers.

48. The rolled edible thin film of claim 36 wherein the edible thin film comprises a filler chosen from the group consisting of microcrystalline cellulose, cellulose polymers, including wood, magnesium and calcium carbonate, ground limestone, silicates, including magnesium and aluminum silicate, clay, talc, titanium dioxide, mono-calcium phosphate, di-calcium phosphate, and tri-calcium phosphate.

49. The rolled edible thin film of claim 36 wherein the edible thin film comprises a plasticizer chosen from the group consisting of tallow, hydrogenated tallow, hydrogenated and partially hydrogenated vegetable oils, cocoa butter, sorbitol, glycerin, polyethylene glycol, propylene glycol, invert sugars, corn syrup, lecithin, hydrogenated lecithin, mono-, di- and triglycerides, acetylated monoglycerides, and fatty acids including palmitic, oleic, and linoleic acids.

50. The rolled edible thin film of claim 36 wherein the edible thin film includes a medicament chosen from the group consisting of pH control agents, tartar control, caries control, whitening agents, enzymes, breath freshening agents, anti-plaque/anti-gingivitis agents, saliva stimulating agents, pharmaceutical agents, nutraceutical agents, vitamins, and minerals.

51. The rolled edible thin film of claim 36 wherein the edible thin film includes a flavor chosen from the group consisting of essential oils, synthetic flavors, citrus oil, fruit essences, peppermint oil, spearmint oil, mint oils, clove oils, oil of wintergreen, anise and the like, flavor oils with germ killing properties including menthol, eucalyptol, and thymol.

52. The rolled edible thin film of claim 36 wherein the edible thin film includes an emulsifier chosen from the group consisting of lecithin, food-grade non-ionic emulsifiers, such as fatty acids (C₁₀-C₁₈), mono and diacyl glycerides, ox bile extract, polyglycerol esters, polyethylene sorbitan esters, propylene glycol, sorbitan monopalmitate, and sorbitan tristerate.

53. A rolled edible thin film comprising an elongated body having a length of at least one foot when unrolled.

54. The rolled edible thin film of claim 53 comprising a film former and a flavor.

55. The rolled edible thin film of claim 53 wherein the elongated body has a plurality of segments.

56. The rolled edible thin film of claim 53 wherein the edible thin film has at least two flavors.

57. The rolled edible thin film of claim 53 wherein the elongated body includes a plurality of scored lines.

58. The rolled edible thin film of claim 53 wherein the edible thin film has at least two colors.

59. The rolled edible thin film of claim 53 wherein the edible thin film includes sides that are not parallel.

60. The rolled edible thin film of claim 53 wherein the edible thin film includes a surface that is textured.

61. The rolled edible thin film of claim 53 wherein the edible thin film releases color to dye the tongue of the consumer.

62. The rolled edible thin film of claim 53 wherein at least one side of the edible thin film product includes a design.

63. The rolled edible thin film of claim 53 wherein the edible thin film is so constructed and arranged so as to create a tongue tattoo when dissolved in the mouth of a consumer.

64. The rolled edible thin film of claim 53 wherein the edible thin film includes ingredients that create an oral sensation as the product dissolves in the mouth of the consumer.

65. The rolled edible thin film of claim 53 wherein the edible thin film comprises a film former chosen from the group consisting of carboxymethylcellulose, methylcellulose, hydroxypropylmethylcellulose, guar gum, locust bean gum, xanthan gum, carrageenan, algins, propylene glycol, pullulan, levan, elsinan, pectins, chitosan, gum arabic, native starches including corn starch, waxy maize starch, high-amylose corn starch, potato, tapioca, rice and wheat starch, modified starches including acid modified, bleached, oxidized, esterified, etherified, crosslinked, and enzymatically-treated starches; starch hydrolyzed products including maltodextrin; protein including albumen, gelatin, casein, salts of casein, whey, wheat gluten, zein, and protein derived from soybeans; polymers including polyvinyl pyrrolidone, methycrylate copolymer, and carboxyvinyl copolymers.

66. The rolled edible thin film of claim 53 wherein the edible thin film comprises a filler chosen from the group consisting of microcrystalline cellulose, cellulose polymers, including wood, magnesium and calcium carbonate, ground limestone, silicates, including magnesium and aluminum silicate, clay, talc, titanium dioxide, mono-calcium phosphate, di-calcium phosphate, and tri-calcium phosphate.

67. The rolled edible thin film of claim 53 wherein the edible thin film comprises a plasticizer chosen from the group consisting of tallow, hydrogenated tallow, hydrogenated and partially hydrogenated vegetable oils, cocoa butter, sorbitol, glycerin, polyethylene glycol, propylene glycol, invert sugars, corn syrup, lecithin, hydrogenated lecithin, mono-, di- and triglycerides, acetylated monoglycerides, and fatty acids including palmitic, oleic, and linoleic acids.

68. The rolled edible thin film of claim 53 wherein the edible thin film includes a medicament chosen from the group consisting of pH control agents, tartar control, caries control, whitening agents, enzymes, breath freshening agents, anti-plaque/anti-gingivitis agents, saliva stimulating agents, pharmaceutical agents, nutraceutical agents, vitamins, and minerals.

69. The rolled edible thin film of claim 53 wherein the edible thin film includes a flavor chosen from the group consisting of essential oils, synthetic flavors, citrus oil, fruit essences, peppermint oil, spearmint oil, mint oils, clove oils, oil of wintergreen, anise, flavor oils with germ killing properties including menthol, eucalyptol, and thymol.

70. The rolled edible thin film of claim 53 wherein the edible thin film includes an emulsifier chosen from the group consisting of lecithin, food-grade non-ionic emulsifiers, such as fatty acids (C₁₀-C₁₈), mono and diacyl glycerides, ox bile extract, polyglycerol esters, polyethylene sorbitan esters, propylene glycol, sorbitan monopalmitate, and sorbitan tristerate.

71. A method of producing an edible thin film comprising the steps of:
forming a film comprising a film former;
drying the film;
rolling the film into a roll; and
packaging a resultant edible thin film product in a package that is designed to be provided to a consumer.

72. The method of claim 71 including the steps of forming a mixture of at least one film-forming material in powder form and water.

73. The method of claim 72 including the step of agitating the mixture until the powder is mostly hydrated, adding to the mixture at least one ingredient selected from the group consisting of plasticizers, softening agents, colors, sweeteners, cooling agents, flavors and active ingredients, and blending the mixture to obtain a homogeneous solution.

74. The method of claim 73 including the step of spreading the solution onto a moving substrate and drying the solution on the substrate to create a flexible film.

75. The method of claim 71 wherein the step of rolling the film includes the step of perforating the film layer longitudinally before the film layer exits a drying system.

76. The method of claim 71 wherein the step of rolling the film includes separating the film layer longitudinally with an air knife before it exits a dryer, peeling the film strips from a substrate upon exiting the dryer, and winding the film strips onto individual take-up rolls.

77. The method of claim 71 wherein the step of rolling the film includes spraying the solution onto multiple narrow carriers that pass through a drying system and are collected individually.

78. The method of claim 71 including the step of slitting the film accumulated onto a roller into narrower width ribbons.

79. The method of claim 71 including the step of creating scored lines in the film.

80. The method of claim 71 including the step of creating segments in the film.

81. The method of claim 71 including the step of creasing the film.

82. The method of claim 71 including the step of locating a substrate between surfaces of the film in the roll.

83. A method of providing edible thin film to a consumer comprising the steps of:
producing a rolled edible thin film;
placing the rolled edible thin film in a container; and
providing the rolled edible thin film in a container to a consumer.

84. The method of claim 83 including the step of locating between layers of the rolled edible thin film means for preventing the edible thin film from sticking to itself.

85. A method for marketing edible thin films comprising the steps of marketing to a consumer a rolled edible thin film.

86. The method of claim 85 including the step of packaging the edible thin film in a container.

87. A rolled edible thin film product comprising a body including a top and a bottom surface, at least one of the bottom and top surface being removably covered by a substrate.

88. The rolled edible thin film product of claim 87 wherein the substrate includes paper.

89. The rolled edible thin film product of claim 87 wherein the substrate includes plastic.

90. A rolled edible thin film product including a body that is wrapped around itself to define a plurality of layers and means for separating the layers being disposed between the layers.

91. The rolled edible thin film product of claim 90 wherein the means are chosen from the group consisting of paper, plastic, and edible powder.

92. The rolled edible thin film product of claim 91 wherein the edible powder includes a sweetener.
